(19) United States
(12) Patent Application Publication
(10) Pub. No.: US 2021/0294489 A1
(43) Pub. Date: Sep. 23, 2021

(54) Surface Confined Self-Mixing Interferometry Through Frustrated Total Internal Reflection for an Electronic Device

(71) Applicant: Apple Inc., Cupertino, CA (US)

(72) Inventors: Xin Li, San Jose, CA (US); David D. Dashevsky, Cupertino, CA (US); Sriram Moorthy, Sunnyvale, CA (US)

(21) Appl. No.: 16/827,646

(22) Filed: Mar. 23, 2020

(51) Int. Cl. G06F 3/0488; G04G 21/08; G01B 9/02

(52) U.S. Cl. CPC G06F 3/04883; G01B 9/02092; G04G 21/08

(57) ABSTRACT

A self-mixing interference sensor may be positioned within an electronic device and may be configured to detect a gesture on a user input surface of the electronic device. A beam of electromagnetic radiation may be emitted from the self-mixing interference sensor toward the user input surface. When an object with a suitable refractive index is not in contact with the user input surface, the beam of electromagnetic radiation may reflect away from the self-mixing interference sensor. When an object with a suitable refractive index is in contact with the user input surface, the beam of electromagnetic radiation may reflect back into the self-mixing interference sensor and may undergo a self-mixing process. A property of the object in contact with the surface of the user input device may be detected by measuring a change in an optical property of the beam of electromagnetic radiation.

### FIELD

Embodiments described herein relate to electronic devices and, in particular, to electronic devices that incorporate optical sensing techniques, such as self-mixing interferometry, to provide input control instruments and options to a user.

### BACKGROUND

Many people routinely interact with electronic devices to perform a variety of tasks. Such electronic devices are varied in aesthetics, performance, and function and may include cell phones, tablet computers, desktop computers, personal digital assistants, and wearable electronics. Many electronic devices include input devices that an individual may use to send instructions to an electronic device for the purpose of operating and interacting with the electronic device. Examples of typical input devices include removable external devices, such as a mouse, a keyboard, and a microphone, and integrated devices, such as buttons, dials, touch screens, and sensors.

Many types of input devices include moving parts. For example, an input device integrated as a rotating dial on a wearable electronic device is generally configured to be rotated, about an axis, by a user. For a typical rotating dial gaps may surround the periphery of the rotating dial. These gaps may result in contaminants, such as dust or dirt, entering into an internal portion of an electronic device, which may detrimentally affect the performance of the electronic device. Moving parts may also be more prone to damage, may result in costly repairs, and/or may suffer from variable input sensitivity.

Other types of input devices include touch-sensitive sensors which may be configured to detect a user's touch. Such a touch may be used to control the operation of an electronic device. These types of input devices may, for example, be difficult to implement within a small area, may provide variable tactile feedback to a user, and/or may register unintentional input commands. For example, an optical sensor may be unable to consistently detect the difference between a user's finger in contact with a surface and a user's finger slightly above the surface. Many optical sensors, therefore, may result in frustration for a user during, for example, a scrolling operation if sensors cannot detect the difference between scrolling motions made directly on an input surface and adjustment motions made slightly above the input surface.

### SUMMARY

Embodiments described herein may relate to apparatuses, systems, and/or methods for providing user input to an electronic device. The electronic device may include an input dial with integrated optical sensors, such as described herein. In some embodiments, a self-mixing interference sensor may be provided within a user input device on a wearable device. The self-mixing interference sensor may emit a beam of electromagnetic radiation toward a user input surface of the user input device. When air surrounds the user input device, the beam of electromagnetic radiation may experience total internal reflection and may reflect off of the user input surface of the user input device and away from the self-mixing interference sensor. When an object with a sufficient refractive index (e.g., a body part of a user) is in contact with the user input device, the beam of electromagnetic radiation may reflect back into the self-mixing interference sensor. The reflected light may then change a property of the emitted beam of electromagnetic radiation and such property may be measured to determine a physical property (e.g., a speed and velocity) of the object.

In some embodiments, an electronic watch may be provided. The electronic watch may include a housing; a user input device protruding from the housing and defining a user input surface; and a self-mixing interference sensor including an electromagnetic radiation source. The electromagnetic radiation source may emit a beam of electromagnetic radiation toward the user input surface. The user input surface may be transparent to the beam of electromagnetic radiation. The angle of incidence of the beam of electromagnetic radiation may be, with respect to the user input surface, greater than a first critical angle of a first boundary condition between the user input surface and air and less than a second critical angle of a second boundary condition between the user input surface and a body part of a user.

A self-mixing interference sensor may include a circuit which monitors either a junction voltage or a bias current of an electromagnetic radiation source. The circuit may additionally be configured to monitor both the junction voltage and the bias current.

In some embodiments, a beam of electromagnetic radiation within an electronic watch may be emitted from a self-mixing interference sensor and may reflect back into the self-mixing interference sensor when a body part of a user is contacting a user input surface of the electronic watch. The self-mixing interference sensor may identify a type of gesture on the user input surface in response to detecting an optical property of the reflected beam of electromagnetic radiation.

An output of a self-mixing interference sensor may contain information related to at least one of a velocity or a direction of motion of a body part of a user as the body part moves across a user input surface. The output of the self-mixing interference sensor may be a signal created in response to an analysis of a beam of electromagnetic radiation reflected back into the self-mixing interference sensor.

In some embodiments, an electronic watch may include a stationary crown and a circumference of the stationary crown may define a user input surface. The stationary crown may resist a force imparted on the stationary crown and may not move with respect to a surrounding housing.

A self-mixing interference sensor may produce an output indicative of changes from a first boundary condition of an input device and a second boundary condition of the input device, and vice versa.

In some embodiments, an electronic device may include a frame; a protrusion extending from the frame and defining an input surface of the electronic device; a self-mixing interference sensor configured to emit a beam of electromagnetic radiation toward the input surface; and a processor configured to detect a frustrated total internal reflection condition of the beam of electromagnetic radiation, at least partly in response to an output of the self-mixing interference sensor.

In some embodiments, a self-mixing interference sensor may be positioned with a cavity of a protrusion (e.g., a watch crown). In other embodiments, a self-mixing interference sensor may be positioned within a cavity of a frame (e.g., a watch body housing).

In an electronic device, at least a majority of a beam of electromagnetic radiation emitted from a self-mixing interference sensor may reflect away from the self-mixing interference sensor when air contacts an input surface of the electronic device at a point where the beam of electromagnetic radiation contacts the input surface.

In an electronic device, a portion of a beam of electromagnetic radiation emitted from a self-mixing interference sensor may reflect back into the self-mixing interference sensor when a body part of a user contacts an input surface of the electronic device at a point where the beam of electromagnetic radiation contacts the input surface.

In some embodiments, a processor may identify a user input when a portion of a beam of electromagnetic radiation emitted from a self-mixing interference sensor reflects back into the self-mixing interference sensor and exceeds a threshold amount.

A processor may identify a speed of a user's body part when an amount of a beam of electromagnetic radiation emitted from a self-mixing interference sensor reflects back into the self-mixing interference sensor and changes more than a threshold amount.

In some embodiments, an electronic watch may include a hollow crown defining an interior cavity and having a first refractive index and a light-emitting sensor positioned within the interior cavity and configured to emit a beam of electromagnetic radiation toward an exterior surface of the hollow crown.

A beam of electromagnetic radiation emitted from a light-emitting sensor may reflect off of an interior surface of a hollow crown and away from the light-emitting sensor when an incident angle of the beam of electromagnetic radiation is greater than a first critical angle between a first boundary of a first medium having a second refractive index and the hollow crown having the first refractive index. The beam of electromagnetic radiation may reflect off of the exterior surface and back into the light-emitting sensor when the incident angle of the beam of electromagnetic radiation is less than a second critical angle between a second boundary of a second medium having a third refractive index and the hollow crown having the first refractive index.

A light-emitting sensor may detect a contact between a second medium and a hollow crown. The hollow crown may be transparent to a beam of electromagnetic radiation. The light-emitting sensor may signal an input when a threshold amount of the beam of electromagnetic radiation reflects off of the exterior surface and back into the light-emitting sensor.

In some embodiments, a beam of electromagnetic radiation may contact a circumference of a hollow crown before reflecting back into a light-emitting sensor as a reflected beam of electromagnetic radiation. The light-emitting sensor may detect a velocity of a gesture based on an optical property of the reflected beam of electromagnetic radiation.

### BRIEF DESCRIPTION OF THE DRAWINGS

Reference will now be made to representative embodiments illustrated in the accompanying figures. It should be understood that the following descriptions are not intended to limit this disclosure to one included embodiment. To the contrary, the disclosure provided herein is intended to cover alternatives, modifications, and equivalents, as may be included within the spirit and scope of the described embodiments and as defined by the appended claims.

FIG. 1 depicts an isometric view of an example electronic watch having a user input device, such as described herein.

FIG. 2 depicts a cutaway view of a portion of an electronic watch including a watch crown assembly, such as described herein.

FIG. 3A depicts exemplary components of a self-mixing interference sensor and an operation of the self-mixing interference sensor when a beam of electromagnetic radiation, an output of the self-mixing interference sensor, passes through a transparent material, such as described herein.

FIG. 3B depicts exemplary components of a self-mixing interference sensor and an operation of the self-mixing interference sensor when a beam of electromagnetic radiation, an output of the self-mixing interference sensor, experiences total internal reflection, such as described herein.

FIG. 3C depicts exemplary components of a self-mixing interference sensor and an operation of the self-mixing interference sensor when a beam of electromagnetic radiation, an output of the self-mixing interference sensor, experiences frustrated total internal reflection, such as described herein.

FIG. 4 illustrates properties of a self-mixing interference operation with respect to a self-mixing interference sensor when an object is in contact with a transparent material to which a beam of electromagnetic radiation is directed, such as described herein.

FIG. 5 illustrates properties of a self-mixing interference operation with respect to a self-mixing interference sensor due to a movement of an object in contact with a transparent material to which a beam of electromagnetic radiation is directed, such as described herein.

FIG. 6A depicts a cross-sectional view of a part of a user input device when no object is in contact with a user input surface of the user input device, such as described herein.

FIG. 6B depicts a cross-sectional view of a part of a user input device when a user's finger is in contact with a user input surface of the user input device, such as described herein.

FIG. 6C depicts a cross-sectional view of a part of a user input device when a user's finger is hovering above a user input surface of the user input device, such as described herein.

FIG. 7 illustrates a flowchart of an example method of detecting an object with a sufficient refractive index when the object is in contact with a user input device, such as described herein.

FIG. 8 depicts a cross-sectional view of a part of a user input device with multiple self-mixing interference sensors and associated structures, such as described herein.

FIG. 9 depicts a cross-sectional view of a part of a user input device when a self-mixing interference sensor directs a beam of electromagnetic radiation toward a top user input surface of the user input device, such as described herein.

FIG. 10A depicts an example electronic watch having a user input device and a display with associated graphical user interface, such as described herein.

FIG. 10B depicts a change in the graphical user interface of the electronic watch depicted in FIG. 10A as an object moves around a side user input surface of a user input device, such as described herein.

FIG. 11A depicts an example electronic watch having a user input device and an image presented on a display, such as described herein.

FIG. 11B depicts an example zoom operation in the graphical user interface of the electronic watch depicted in FIG. 11A as an object contacts a top user input surface of a user input device, such as described herein.

FIG. 12A depicts an example electronic watch having a user input device and text presented on a display, such as described herein.

FIG. 12B depicts an example input operation in the graphical user interface of the electronic watch depicted in FIG. 12A as an object moves across a top user input surface of a user input device, such as described herein.

FIG. 13 illustrates a sample electrical block diagram of an electronic device, such as described herein.

The use of cross-hatching or shading in the accompanying figures is generally provided to clarify the boundaries between adjacent elements and also to facilitate legibility of the figures. Accordingly, neither the presence nor the absence of cross-hatching or shading conveys or indicates any preference or requirement for particular materials, material properties, element proportions, element dimensions, commonalities of similarly illustrated elements, or any other characteristic, attribute, or property for any element illustrated in the accompanying figures.

Additionally, it should be understood that the proportions and dimensions (either relative or absolute) of the various features and elements (and collections and groupings thereof), and the boundaries, separations, and positional relationships presented therebetween, are provided in the accompanying figures merely to facilitate an understanding of the various embodiments described herein, may not necessarily be presented or illustrated to scale, and are not intended to indicate any preference or requirement for an illustrated embodiment to the exclusion of embodiments described with reference thereto.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The following disclosure relates to techniques for detecting an input on a watch crown (e.g., a digital crown). The techniques utilize a sensor system that includes one or more coherent or partially coherent electromagnetic radiation sources, such as edge-emitting laser diodes, vertical cavity surface emitting lasers (VCSELs), quantum dot lasers (QDLs), or superluminescent diodes. An electromagnetic radiation source of the sensor system may emit a beam of electromagnetic radiation (e.g., a beam of light) toward a watch crown surface (e.g., toward an interior surface on a side surface of a cap of the crown).

As discussed herein, some described embodiments are directed to self-mixing interference sensors, such as may be used for touch or input sensors, and their structures. Self-mixing interference sensors may use VCSEL diodes and associated resonance cavity photodetectors (RCPDs). An electronic device may use such a self-mixing interference sensor as part of detecting a displacement, distance, motion, speed, or velocity of an object in contact with an input surface, such as a surface on a watch dial.

In some embodiments, a watch crown surface may be optically transparent to a wavelength of a beam of electromagnetic radiation emitted from an electromagnetic radiation source. The watch crown surface may additionally be optically transparent in the visible electromagnetic spectrum (e.g., transparent to a user's eye) or may be optically opaque in the visible electromagnetic spectrum (e.g., opaque to a user's eye). In certain embodiments, the watch crown may be made of a uniform material or may comprise multiple regions made of different materials. In some embodiments, the watch crown may be made of a uniform material with a high index of refraction with respect to a beam of electromagnetic radiation emitted from an electromagnetic radiation source. A material of a watch crown may be selected based on the Fresnel equations, which describe the reflection and refraction of incident light at a boundary between two materials.

In some embodiments, a beam of electromagnetic radiation may be directed to an internal surface of a watch crown at an angle greater than a critical angle of a boundary between the watch crown and an external environment, as defined by Snell's law. When the angle of incidence of the beam of electromagnetic radiation is greater than the critical angle, the beam of electromagnetic radiation may completely reflect off of an internal surface of the watch crown, referred to as a total internal reflection.

In some embodiments, when an object contacts an exterior surface of the watch crown, the critical angle at the point where the beam of electromagnetic radiation contacts the internal surface of the watch crown may change due to the change in surrounding medium. This change in critical angle may result in the beam of electromagnetic radiation no longer undergoing total internal reflection, which may permit the beam to transmit directly to the object. Once the beam contacts the object, the beam may reflect, as feedback, back into the electromagnetic radiation source.

In some cases, the feedback undergoes coherent mixing within a resonant cavity of the electromagnetic radiation source. The coherent mixing of the electromagnetic radiation may include a mixing of a first amount of electromagnetic radiation generated by the electromagnetic radiation and a second amount of electromagnetic radiation as feedback (e.g., by reflection) into the resonant cavity. The coherent mixing of electromagnetic radiation may modify an electric field, carrier distribution, and lasing threshold of the resonant cavity, which may produce a measurable interference, or interferometric, signal. Parameters of the interference signal may be measured by measuring and/or monitoring a junction voltage of the electromagnetic radiation source by measuring a bias current of the electromagnetic radiation source or by measuring a power (e.g., an optical power) of the beam of electromagnetic radiation. Each of the junction voltage, the bias current, and the power may modulate in response to the coherent mixing. The junction voltage and/or bias current may be measured by an electrical sensor and the power may be measured by an optoelectronic sensor.

A measurement of the interference signal may be used to determine a position and/or velocity of an object in contact with a watch crown. For example, the interference signal may be measured over a particular time interval and may be input into a fast Fourier transform (FFT) algorithm to determine a spectral density of the interference signal. The strongest frequency component of the interference signal may be interpreted as a Doppler shift between the electromagnetic radiation generated by an electromagnetic radiation source and electromagnetic radiation received back into a resonant cavity of the electromagnetic radiation source (e.g., a self-mixing process). Hence, the Doppler shift contains information about a velocity of the object on an external surface of the watch crown. Because of the nonlinear distortion that occurs in the coherent mixing process, the phase of the second harmonic of the interference signal contains information about the velocity of the object on the external surface of the watch crown. Alternatively or additionally, movement of an object in contact with a crown may be deduced in the time domain. Further, additional information about an object may be deduced by the interference signal including whether the watch crown has contaminants on the external surface, whether an individual is making contact with the watch crown, and biometric health information (e.g., a heartbeat, a stress level, and a blood oxygenation content) of an individual making contact with the watch crown.

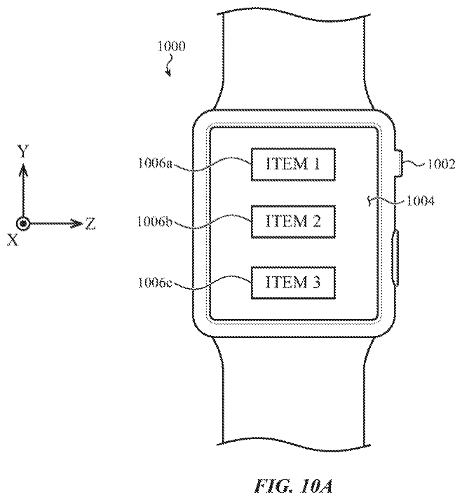

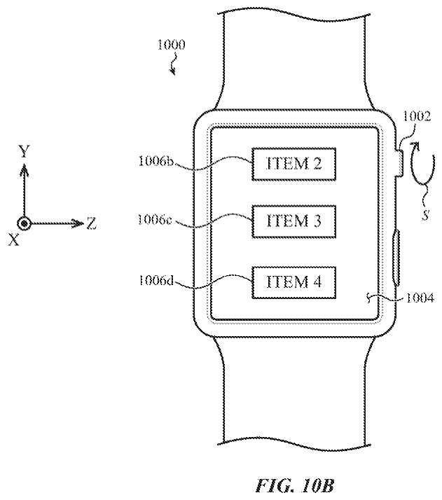

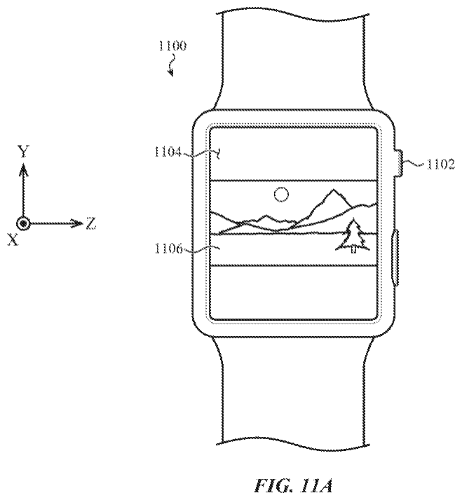

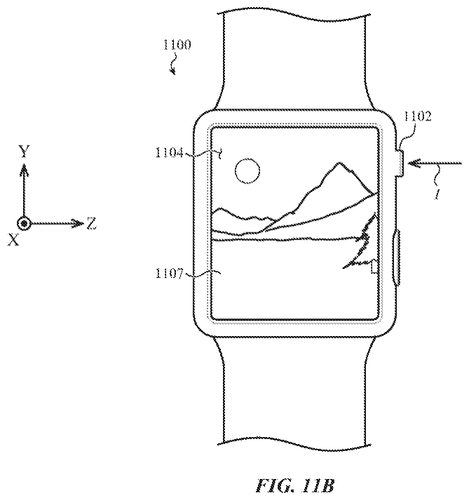

The measurement of the interference signal may result in an input signal when a threshold value is met. For example, the measured junction voltage and/or bias current measurement may not result in an input signal with the measured voltage and/or current does not meet or surpass a predetermined threshold voltage and/or current. When the measured voltage and/or current does meet or surpass a predetermined threshold voltage and/or current, an operation of an electronic device may be initiated. For example, when a predetermined threshold voltage and/or current is met or surpassed, the operations as described with respect to FIGS. 10A-12B may be performed.

In some embodiments, a watch crown assembly may include a watch crown, an electromagnetic radiation source, and a sensor. The watch crown may include a hollow cavity and the hollow cavity may contain the electromagnetic radiation source and the sensor. The electromagnetic radiation source may emit a beam of electromagnetic radiation toward an internal surface of the watch crown at a predetermined angle. The predetermined angle may be set in such a way that permits a reflection of the beam away from the electromagnetic radiation source when no object is in contact with the watch crown. The same predetermined angle may also allow the reflection of the beam back into a cavity of the electromagnetic radiation when an object is in contact with the watch crown. The watch crown may be stationary (i.e., fixed with respect to a watch housing) or may be rotatable (i.e., rotatable with respect to the watch housing). The sensors may be combined with the electromagnetic radiation source, may be positioned apart from the electromagnetic source, and may be one or any number of sensors.

These and other embodiments are described below with reference to FIGS. 1-13. However, those skilled in the art will readily appreciate that the detailed description given herein with respect to these figures is for explanatory purposes only and should not be construed as limiting.

FIG. 1 depicts an isometric view of an example electronic watch 100 having a user input device 110 (e.g., a stationary watch crown). The electronic watch 100 may include a watch body 102 and a watch band 104. The watch body 102 may include a housing 106. As an example, the housing 106 may define a perimeter (e.g., a set of edges or sidewalls) of the watch body 102. The housing 106 may also define part or all of a watch face and/or a watch back. The housing 106 may be formed by one or more housing members which may be formed from, for example, metallic, plastic, ceramic, crystal, and/or glass materials. The user input device 110 may protrude from the housing 106, as depicted in FIG. 1.

In some embodiments, as shown, the housing 106 may define one or more of a watch face opening, a watch crown shaft opening, a frame, and/or a button opening. The housing 106 may also define a watch back opening. A display 108 may be positioned within the housing 106 such that the display 108 provides visual elements to a user of the electronic watch 100. The display 108 may be configured to depict a graphical output of the electronic watch 100 and a user may interact with the graphical output (e.g., by using a finger or stylus). As one example, a user may interact with a graphic, icon, or the like by touching or pressing a corresponding location on the display 108. The display 108 may be protected by, or include, a cover. In some examples, the cover may include a crystal, such as a sapphire crystal, and/or may be formed of glass, plastic, or other materials. A second cover may be mounted to the housing 106 such that it covers a watch back opening. In alternate embodiments, the housing 106 may not include the watch face opening, the watch back opening, the watch crown shaft opening, and/or the button opening.

The watch body 102 may include at least one user input device (e.g., the user input device 110) or selection device, such as a crown, scroll wheel, knob, dial, button, or the like, which may be operated by a user of the electronic watch 100. For example, the watch body 102 may include the user input device 110. In some embodiments, the user input device 110 may be fixed to the watch body 102 so that the user input device 110 is not movable, depressible, and/or rotatable. For example, the user input device 110 may be a protrusion of the housing 106. The user input device 110 may define an input surface, and a user of the electronic watch 100 may interact with the input surface to control a function of the electronic watch 100, as discussed herein. For example, a user may use the user input device 110 to manipulate or select various elements displayed on the display 108, to adjust a volume of a speaker of the electronic watch 100, to turn the electronic watch 100 on or off, or to provide input to a system utility or user application. In other embodiments, the user input device 110 may include a shaft that extends through a crown shaft opening in the housing 106, which may allow for the movement, rotation, and/or depression of the user input device 110. In addition to the user input device 110, the watch body 102 may include a button 112 (e.g., a second user input device). The button 112 may extend through a button opening in the housing 106 and may, for example, be used to control a power status of the electronic watch 100, initiate a payment operation, initiate a phone call, or provide input to a graphical user interface of the electronic watch 100. In some embodiments, the button 112 may be depressible with respect to the watch body 102. In other embodiments, the button 112 may be fixed with respect to the watch body 102. Either or both of the user input device 110 and button 112 may be provided with self-mixing interference sensors configured to detect a user input, as discussed herein.

The housing 106 may additionally include structures for attaching the watch band 104 to the watch body 102. In some cases, the structures may include elongate recesses or apertures through which ends of the watch band 104 may be inserted and affixed to the watch body 102. In other cases, the structures may include indents (e.g., dimples and depressions) in the housing 106, which may receive ends of spring pins that are attached or threaded through ends of the watch band 104 to attach the watch band 104 to the watch body 102.

The watch band 104 may additionally be used to secure the electronic watch 100 to a user, another device, a retaining mechanism, and so on. The watch band 104 may be made of any suitable material including plastic, silicone rubber, polyurethane rubber, ceramic, nylon, fabric, stainless steel, leather, and the like. The watch band 104 may comprise various sensors to, for example, measure a blood oxygenation level or heartrate of a user.

Other electronic devices that may incorporate user input devices and/or crowns include other wearable electronic devices, other time-keeping devices, other health monitoring or fitness devices, other portable computing devices, mobile phones and/or smart phones, tablet computing devices, digital media players, and the like.

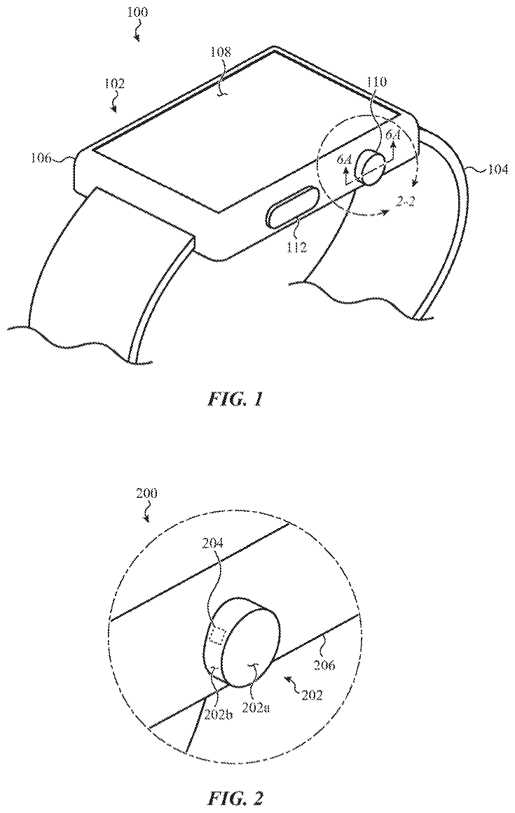

FIG. 2 depicts a cutaway view of a portion (e.g., the portion bounded by boundary 2-2 in FIG. 1) of a watch body (e.g., the watch body 102 shown in FIG. 1) including a watch crown assembly 200. The watch crown assembly 200 may include a watch crown 202, a self-mixing interference sensor 204, and a housing 206. The watch crown 202 may protrude from the watch crown assembly 200 and may further define a top user input surface 202a defining a top of the watch crown 202 and a side user input surface 202b defining a perimeter of the watch crown 202. The self-mixing interference sensor 204 may detect the presence and/or movement of an object in contact with the top user input surface 202a and/or the side user input surface 202b. The self-mixing interference sensor 204 may be mounted within an internal cavity of the watch crown 202, either in whole or in part, and/or may, in some cases, be mounted within a portion of the housing 206. In some embodiments, the self-mixing interference sensor 204 may be provided with other and/or additional features of the watch body 102. For example, the self-mixing interference sensor 204 may be located within and/or proximate the button 112. In yet further embodiments, the self-mixing interference sensor 204 may be provided to a flat and/or edge portion of the housing 106 and not with any buttons or protrusions.

In some embodiments, the self-mixing interference sensor 204 may include a coherent or partially coherent electromagnetic radiation source (e.g., one or more edge-emitting laser diodes, VCSELs, QDLs, or superluminescent diodes) and a sensor (e.g., one or more electronic or optoelectronic circuits). The electromagnetic radiation source may emit a beam of electromagnetic radiation (e.g., visible, infrared, or ultraviolet light) toward a surface of the watch crown 202 (e.g., toward the side user input surface 202b of the watch crown 202). The electromagnetic radiation source may additionally be operated in a continuous wave mode, a pulsed mode, or any combination thereof. In the case of an electromagnetic radiation source being operated in a pulsed mode, the electromagnetic radiation source may be operated to emit electromagnetic radiation at a regular or irregular interval. An emitted beam of electromagnetic radiation may depend on a coherent mixing of electromagnetic radiation within a resonant cavity of the electromagnetic radiation source, as discussed herein. The coherent mixing of electromagnetic radiation may include a mixing of a first amount of electromagnetic radiation initially generated by the electromagnetic radiation source and a second amount of electromagnetic radiation emitted by the electromagnetic radiation source and redirected (e.g., by reflection or by a scattering) into the resonant cavity of the electromagnetic radiation source. In some cases, an electromagnetic radiation source may be coupled to a temperature controller to stabilize the electromagnetic radiation source's operating temperature. In some embodiments, more electromagnetic radiation source/sensor pairs may be included in the watch crown 202 in order to increase a measurement resolution and/or increase the self-mixing interference sensor's 204 signal-to-noise ratio.

In embodiments where multiple electromagnetic radiation source/sensor pairs are included in the watch crown 202, the multiple electromagnetic radiation sources may be operated in a continuous wave mode, a pulsed mode, or any combination thereof. In the case the multiple electromagnetic radiation sources are operated in a pulsed mode, the electromagnetic radiation sources may be configured to emit electromagnetic radiation at the same time or at different times (e.g., in a time-multiplexed manner that can minimize cross-talk between different electromagnetic radiation source/sensor pairs).

Though the watch crown 202 is depicted as a circular feature in FIG. 2, the shape of the watch crown is not limited as such. In alternate embodiments, the watch crown 202 may be, for example, ellipsoidal, rectangular, polygonal, or irregularly shaped. The watch crown 202 may additionally be provided with surface features such as, for example, grooves, texture, and/or finishes. These surface features may, for example, establish a more secure contact between a user and the watch crown 202 and/or may reduce slipping of a user's finger as the user's finger makes contact with the watch crown 202.

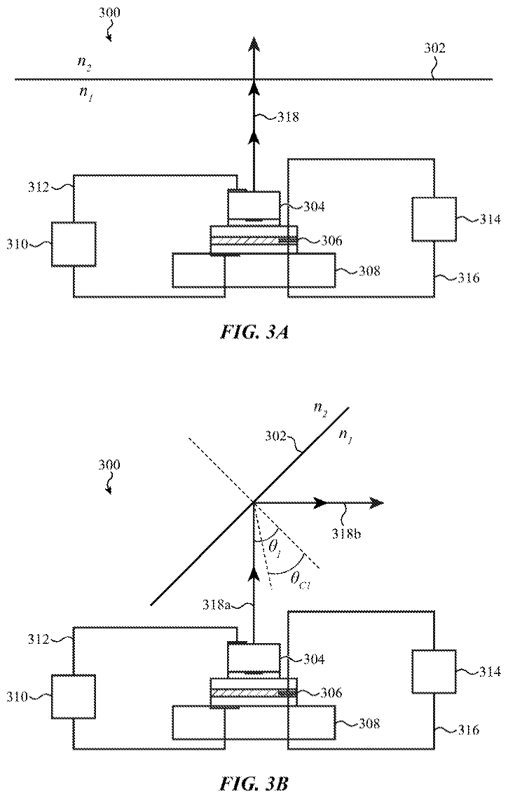

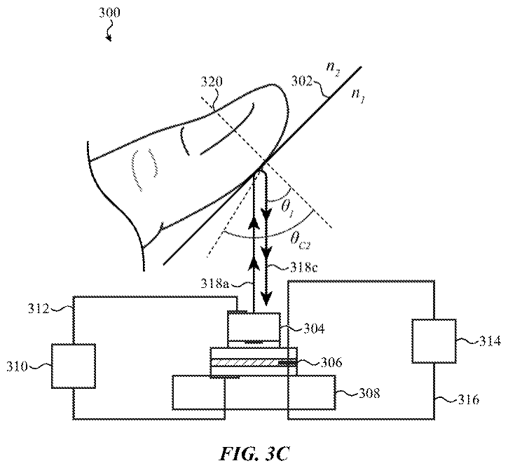

FIGS. 3A-3C depict example embodiments where a system 300 includes an electromagnetic radiation source 304 (e.g., a light-emitting sensor) configured to emit a beam of electromagnetic radiation toward a surface of a transparent material 302. FIG. 3A depicts a configuration of a system 300 where an electromagnetic radiation source 304 (e.g., a laser light source) is configured to emit a beam of electromagnetic radiation 318 toward a perpendicular surface of a transparent material 302. The transparent material 302 need only be transparent with respect to the beam of electromagnetic radiation 318, so that the beam of electromagnetic radiation 318 passes through the transparent material 302 without significant scattering, refraction, and/or reflection. The transparent material 302 may additionally be transparent with respect to the visible spectrum (e.g., transparent to a user's eye) or may be opaque with respect to the visible spectrum (e.g., opaque to a user's eye). In the embodiment depicted in FIGS. 3A-3C, the electromagnetic radiation source 304, and associated components, are provided within the transparent material 302. In some embodiments, the electromagnetic radiation source 304 and associated components may be provided outside the transparent material 302 in various fashions (e.g., the electromagnetic radiation source 304 may abut the transparent material 302 or may have an air gap between the transparent material 302 and the electromagnetic radiation source 304) and may direct the beam of electromagnetic radiation 318 toward the transparent material 302.

In the embodiments shown in FIGS. 3A-3C, the electromagnetic radiation source 304 is a VCSEL diode, though other types of electromagnetic radiation sources (e.g., edge emitting lasers, quantum cascade lasers, and QDLs) may be used in some embodiments. Generally and broadly, the electromagnetic radiation source 304 comprises an internal cavity and a set of reflective surfaces (e.g., mirrors) on both ends of the cavity. At least one of the set of reflective surfaces is half-silvered and allows some light to pass through. When a sufficient energy is input into the electromagnetic radiation source 304, a gain material emits light. The emitted light reflects between the set of reflective surfaces and becomes coherent with a predominately single wavelength. The reflected light then exits the cavity through the half-silvered reflective surface and the beam of electromagnetic radiation 318 is created.

In the embodiment of FIG. 3A, the electromagnetic radiation source 304 is configured to emit a beam of electromagnetic radiation 318 approximately perpendicularly toward a surface of the transparent material 302 so that the beam of electromagnetic radiation 318 passes through the surface of the transparent material 302.

The electromagnetic radiation source 304 may be powered by drive electronics 310, which may be coupled to the electromagnetic radiation source 304 by primary connections 312. The primary connections 312 may be wires, leads on a printed circuit board, or any other connection. The drive electronics 310 may provide a bias voltage and/or a bias current to the electromagnetic radiation source 304. The drive electronics 310 may be operable to detect changes in an electrical parameter of the electromagnetic radiation source 304 caused by self-mixing interference of cavity light and reflected laser light, as discussed herein with respect to FIG. 3C, such as junction voltage, bias current, or another electrical parameter.

The system 300 may also include a photodetector 306 coupled to detection electronics 314 by secondary photodetector connections 316 that can supply voltage, current, and/or power to the photodetector 306.

In the configuration of the system 300 shown in FIGS. 3A-3C, the electromagnetic radiation source 304 is combined with the photodetector 306 and mounted on a support 308. The support 308 may be a printed circuit board, a part thereof, or any other suitable structure such as a brace or plate within an electronic device using the system 300. In alternative embodiments, the photodetector 306 may be provided next to and/or adjacent to the electromagnetic radiation source 304, so as to detect scattered light away from the electromagnetic radiation source 304. In some embodiments, the electromagnetic radiation source 304 may be stacked on or below the photodetector 306.

FIG. 3B depicts a configuration of the system 300 where the transparent material 302 is angled at an incident angle θ_{I} with respect to an incident beam of electromagnetic radiation 318a. Though FIG. 3B depicts this configuration with the transparent material 302 angled, either the electromagnetic radiation source 304 or the transparent material 302 may be angled so long as the incident beam of electromagnetic radiation 318a has an incident angle θ_{I} larger than a critical angle θ_{C1} between the transparent material 302 and a surrounding environment, as discussed herein.

In FIG. 3B, the transparent material 302 has a refractive index n₁ and a surrounding environment (e.g., air or water), in contact with a surface of the transparent material 302, has a refractive index n₂. The values of refractive indices n₁ and n₂ may be determined through traditional means or may be known.

By using Snell's law, a critical angle θ_{C1} between a boundary of the transparent material 302 and the surrounding environment may be determined by an application of the formula:

$${θ}_{C 1} = {sin}^{- 1} ( \frac{{n}_{2}}{{n}_{1}} )$$

Once the critical angle θ_{C1} is determined, the transparent material 302 and/or the electromagnetic radiation source 304 may be arranged so that an incident angle θ_{I} of an incident beam of electromagnetic radiation 318a is greater than the determined critical angle θ_{C1}, as depicted in FIG. 3B. In this way, an incident beam of electromagnetic radiation 318a may undergo a total internal reflection at a first boundary condition (e.g., a boundary between the transparent material 302 having a refractive index n₁ and the surrounding environment having a refractive index n₂) and may reflect from the transparent material 302 as reflected beam of electromagnetic radiation 318b. The reflected beam of electromagnetic radiation 318b may reflect away from the electromagnetic radiation source 304 at an angle corresponding to the incident angle θ_{I}.

In total internal reflection, though the incident beam of electromagnetic radiation 318a is completely reflected back into the transparent material 302 (having the refractive index n₁), an evanescent wave component (e.g., an oscillating electromagnetic field) leaks into the surrounding environment (having the refractive index n₂).

As depicted in FIG. 3C, when this evanescent wave component comes into contact with a third medium (e.g., a user's finger 320) having particular refractive properties (e.g., a refractive index n₃ higher than a refractive index n₂), energy (e.g., the incident beam of electromagnetic radiation 318a) may flow across a boundary between the surrounding environment and the third medium. As a result, feedback (e.g., the feedback 318c) may be reflected back into the electromagnetic radiation source 304. The mechanism for this process is called frustrated total internal reflection.

FIG. 3C depicts a configuration of the system 300 in which a user's finger 320 is in contact with a surface of the transparent material 302. The user's finger 320 may have a refractive index n₃ and a critical angle θ_{C2} between a second boundary condition (e.g., a boundary between the transparent material 302 and the user's finger 320) and may be determined by an application of the formula:

$${θ}_{C 2} = {sin}^{- 1} ( \frac{{n}_{3}}{{n}_{1}} )$$

Though the incident angle θ_{I} of an incident beam of electromagnetic radiation 318a may remain the same as in FIG. 3B, if the critical angle θ_{C2} is greater than the incident angle θ_{I} of an incident beam of electromagnetic radiation 318a, the incident beam of electromagnetic radiation 318a may enter the user's finger 320 (e.g., an evanescent wave component of the incident beam of electromagnetic radiation 318a may contact the user's finger 320) and a portion of the electromagnetic radiation may reflect back into a cavity of the electromagnetic radiation source 304 as feedback 318c. In this way, the total internal reflection of the incident beam of electromagnetic radiation 318a may be frustrated (e.g., a frustrated total internal reflection). In some embodiments, the incident angle θ_{I} may be perpendicular, or normal, to the surface defined by the boundary between n₁ and n₂.

Such reception of the feedback 318c into the cavity of the electromagnetic radiation source 304 may cause self-mixing interference of the incident beam of electromagnetic radiation 318a within the cavity with the feedback 318c. As described herein, such self-mixing interference may cause the electromagnetic radiation source's 304 emitted laser light to shift to a steady state optical power different from the emitted power in the absence of received feedback. In addition, self-mixing may cause the electromagnetic radiation source's 304 emitted laser light to shift to a steady state emitted wavelength (or, equivalently, frequency) different from the wavelength emitted in the absence of received feedback. Self-mixing interference may also result in a change of the voltage across the electromagnetic radiation source 304 (when the electromagnetic radiation source 304 is driven at a constant current) and/or a change of the current flowing through the electromagnetic radiation source 304 (when the electromagnetic radiation source 304 is driven at a constant voltage). The photodetector 306 may receive feedback 318c and the detection electronics 314 may detect signals from the photodetector 306 resulting from the received feedback 318c. As discussed herein, the detection electronics 314 may then determine a property (e.g., a velocity and presence) of the user's finger 320. In this way, the photodetector 306 may be able to distinguish between two distinct instances. In a first instance, when the user's finger 320 is not in contact with the transparent material 302, the photodetector 306 may detect a no-contact state. In a second instance, when the user's finger 320 is in contact with the transparent material 302, the photodetector 306 may detect a contact state based on the presence of the feedback 318c.

Though a user's finger 320 is depicted in FIG. 3C, any material with a suitable refractive index may be placed in contact with a surface of the transparent material 302 to initiate a frustrated total internal reflection, in accordance with the disclosure.

Though FIGS. 3A-3C depict the electromagnetic radiation source 304 as within the transparent material 302, this is merely illustrative and other implementations are considered. In a considered embodiment, the electromagnetic radiation source 304 may be in contact with the transparent material 302. In other considered embodiments, a predetermined fluid having a selected refractive index may be placed between the transparent material 302 and the electromagnetic radiation source 304. In some embodiments, the electromagnetic radiation source 304 may be separated from the transparent material 302 by an air gap.

FIG. 4 depicts an operational diagram 400 of self-mixing interference of a beam of electromagnetic radiation (e.g., laser light) within a laser cavity 406 as discussed with reference to FIG. 3C. Hereinafter, solely for simplicity of terminology, the electromagnetic radiation source (e.g., electromagnetic radiation source 304) will be assumed to be a VCSEL. In FIG. 4, the laser cavity 406 has been orientated so that emitted electromagnetic radiation 410 (e.g., laser light) is emitted from the laser cavity 406 to the right, though any orientation (e.g., upwards, downwards, at an angle, or leftwards) may be implemented. The laser cavity 406 has a fixed length between a first mirror 402 and a partially-transparent mirror 404, the fixed length being established during a manufacture of the laser. In an example VCSEL, the first mirror 402 and the partially-transparent mirror 404 are designed according to the principles of distributed Bragg reflectors. Cavity light reflects between the first mirror 402 and the partially-transparent mirror 404 until it escapes through the partially-transparent mirror 404 as an emitted beam of electromagnetic radiation 410.

The emitted beam of electromagnetic radiation 410 travels away from the laser cavity 406 until it intersects or impinges on a target 416 through a transparent material 418. The transparent material 418 may define a user input device and the target 416 may be a user's body part (e.g., the user's finger 320 as shown in FIG. 3C) in contact with a user input surface of the user input device. The distance L from the emission point through the partially-transparent mirror 404 to the target 416 is termed the feedback cavity 408. The distance L of the feedback cavity 408 is fixed as the target 416 is located on a fixed surface (e.g., a fixed user input surface) on the user input device. The absence of the target 416 results in the emitted beam of electromagnetic radiation 410 moving away from the laser cavity 406 (not depicted in FIG. 4).

Once the emitted beam of electromagnetic radiation 410 contacts the target 416 through the transparent material 418, the emitted beam of electromagnetic radiation 410 may be reflected back toward the laser cavity 406 as a reflected beam of electromagnetic radiation 412. The reflected beam of electromagnetic radiation 412 may then be received in the laser cavity 406 through the partially-transparent mirror 404. Once the reflected beam of electromagnetic radiation 412 enters the laser cavity 406, the reflected beam of electromagnetic radiation 412 may mix and/or interact with the cavity electromagnetic radiation. This results in a combined emitted beam of electromagnetic radiation 414. The combined emitted beam of electromagnetic radiation 414 may have characteristics (e.g., a wavelength or an optical power) that differ from the original properties of the emitted beam of electromagnetic radiation 410. In this way, a property (e.g., a speed or a velocity) of the target 416 may be determined.

The combined emitted beam of electromagnetic radiation 414 may be reflected back into the laser cavity 406 as an optical feedback. In this way, characteristics of the emitted beam of electromagnetic radiation (e.g., combined emitted beam of electromagnetic radiation 414) may vary in real-time depending on a characteristic of the target 416.

In an event that the target 416 is not in contact with a surface of the transparent material 418 (as described with respect to FIGS. 3A-3C, above), the emitted beam of electromagnetic radiation 410 may pass through the target 416 and/or may reflect away from the laser cavity 406. In this event, the laser cavity 406 does not receive the reflected beam of electromagnetic radiation 412 and does not undergo a self-mixing interference process. In this way, an input operation (e.g., a gesture on the transparent material 418) may only be detected when a target 416 (e.g., a body part of a user) is in contact with the transparent material 302. This arrangement may prevent unintended inputs when the target 416 is hovering above the transparent material 418.

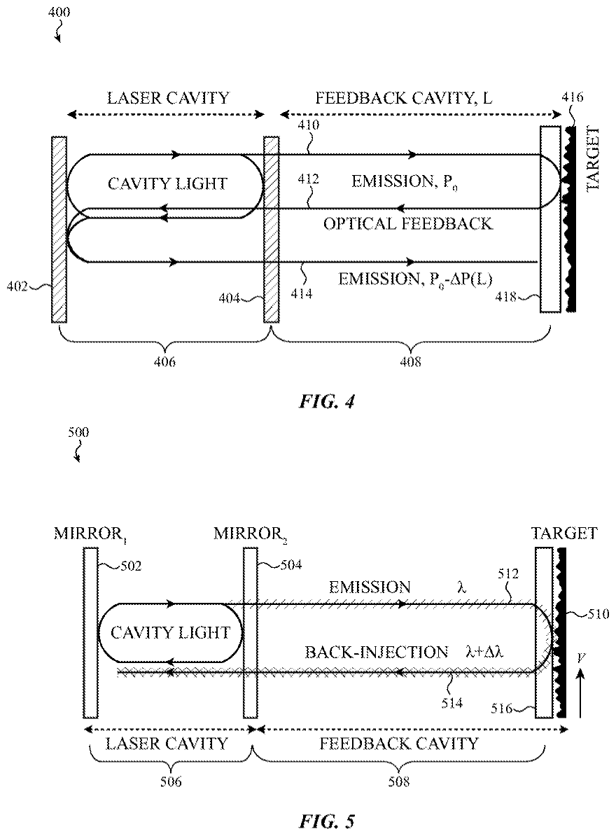

FIG. 5 shows the configuration as discussed in relation to FIG. 4 in the case that the target is now moving. This configuration may represent the situation when a user input surface of an electronic watch is being touched and/or swiped. For example, a user's finger may be performing a gesture on the user input surface in the depicted embodiment. Operational diagram 500 includes a laser cavity 506, a first mirror 502, and a partially-transparent mirror 504. An electromagnetic radiation source is driven to produce an emitted beam of electromagnetic radiation 512 with a wavelength A in accordance with FIG. 4 as discussed above. In the case shown, a target 510 moves across a surface of a transparent material 516 with a velocity v. As the target 510 contains various ridges (e.g., a user's finger with a fingerprint), the precise length of the feedback cavity 508 may undergo slight variations which causes a reflected beam of electromagnetic radiation 514 to be Doppler-shifted to a wavelength λ+Δλ as the reflected beam of electromagnetic radiation 514 enters the laser cavity 506 to undergo self-mixing.

As a result of a Doppler-shifted wavelength being received into the laser cavity 506, the power consumed by the laser diode, as detected by associated electronics, may change and/or the power of reflected and/or cavity light, as detected by a photodetector, may change. The Doppler-shifted wavelength is an example of an optical property that may be received and/or detected by the photodetector. The detected power change may then be used to detect, for example, a movement, presence, speed, and/or velocity of the target 510.

Though FIGS. 4 and 5 show a surface of the target 416 and the target 510 as perpendicular to the emitted beam of electromagnetic radiation 410 and the emitted beam of electromagnetic radiation 512, this arrangement is merely exemplary. As discussed herein, embodiments of the current disclosure may have an incident angle of the emitted beam of electromagnetic radiation 410 and/or an incident angle of the emitted beam of electromagnetic radiation 512 greater than a respective critical angle.

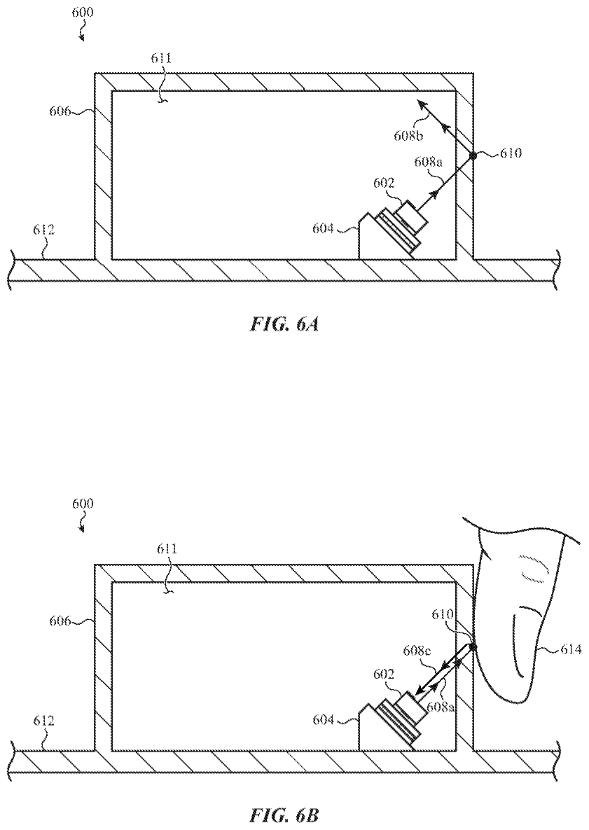

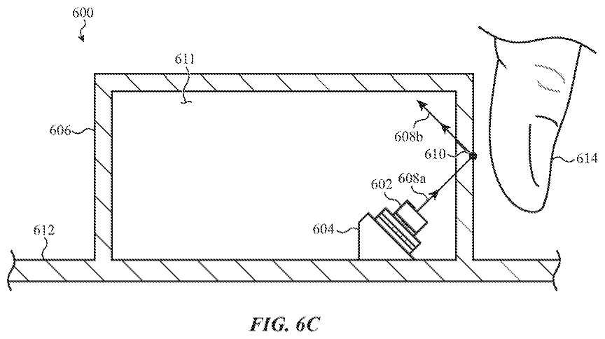

FIGS. 6A-6C illustrate a family of embodiments showing an internal portion of a watch crown 600 (e.g., a user input device) and an electromagnetic radiation source 602 (e.g., a laser light source) positioned within the watch crown 600 and configured to emit a beam of electromagnetic radiation at an angle of incidence. For visual clarity, associated internal components may be simplified or omitted. FIGS. 6A-6C may correspond to a cutaway view of the user input device 110 taken along line 6A-6A, as depicted in FIG. 1.

FIG. 6A shows a cross-sectional view of a part of a watch crown 600 when surrounded by an external environment (e.g., air). The watch crown 600 includes an electromagnetic radiation source 602, a support structure 604, and a user input surface 606. The user input surface 606 is an external surface of the watch crown 600 and may define an external side wall extending around a perimeter of the watch crown 600. The user input surface 606 may define a circumference of the watch crown 600. The electromagnetic radiation source 602 is configured to emit an incident beam of electromagnetic radiation 608a toward the user input surface 606 and at a contact point 610. The contact point 610 may exist when a first boundary condition is present (e.g., when air surrounds the watch crown 600). As discussed above, particularly with respect to FIGS. 3A-3C, the electromagnetic radiation source 602 may emit the incident beam of electromagnetic radiation 608a at an incident angle greater than a first critical angle of a first boundary condition between the crown 600 and air. As such, the incident beam of electromagnetic radiation 608a may experience total internal reflection and may reflect away from the contact point 610 as a reflected beam of electromagnetic radiation 608b. In some embodiments, the incident beam of electromagnetic radiation 608a may be emitted at an angle normal to the user input surface 606.

Though air is disclosed to be surrounding the watch crown 600, other mediums (e.g., water) may also surround the watch crown 600. The incident angle of the incident beam of electromagnetic radiation 608a may be selected so that the incident beam of electromagnetic radiation 608a experiences total internal reflection when surrounded by a variety of different mediums (e.g., air or water). For example, if the watch crown 600 is completely submerged in water, even though the critical angle is different at contact point 610 when compared to the watch crown 600 if surrounded by air, the incident beam of electromagnetic radiation 608a may still totally reflect off of the user input surface 606. By selecting the incident angle to be greater than a variety of critical angles at different boundary conditions, unintentional inputs may be avoided within a variety of environments.

Since the reflected beam of electromagnetic radiation 608b is reflected away from the electromagnetic radiation source 602, no or minimal self-mixing occurs and sensors associated with the electromagnetic radiation source 602 do not detect a user input (e.g., a gesture) on the user input surface 606. The support structure 604 may be provided to attach the electromagnetic radiation source 602 to an associated housing 612 and/or to angle the electromagnetic radiation source 602 to emit the incident beam of electromagnetic radiation 608a at a predetermined angle. In some embodiments, a small amount of scattered electromagnetic radiation (e.g., light) may be reflected back into an internal cavity of the electromagnetic radiation source 602. To avoid detecting an input in response to scattered electromagnetic radiation, a threshold measurement value may be predetermined, where scattered electromagnetic radiation does not result in a user input signal above the threshold measurement value.

The watch crown 600 may also include an internal fluid 611 within an internal cavity defined by the user input surface 606. The internal fluid 611 may surround the electromagnetic radiation source 602 and may be the medium in which the incident beam of electromagnetic radiation 608a travels. The internal fluid 611 may be selected to avoid or minimize reflections, scattering, or diffusion of the incident beam of electromagnetic radiation 608a and/or the reflected beam of electromagnetic radiation 608b. In some embodiments, the internal fluid 611 may be a gas (e.g., a halogen gas, carbon dioxide, nitrogen, or any other gas). In other embodiments, the internal fluid 611 may be a liquid (e.g., an oil, water, or a perfluoroalkane). In some embodiments, the internal fluid 611 may be omitted and may be replaced by, for example, a vacuum. In some embodiments, the internal cavity defined by the user input surface 606 may be omitted. In these embodiments, the internal cavity may be replaced by the material comprising the user input surface 606 such that the user input surface 606 defines a solid watch crown 600.

FIG. 6B shows a cross-sectional view of a part of a watch crown 600 when a user's finger 614 is in contact with a user input surface 606. As discussed with reference to FIG. 3C, above, when an object with a threshold refractive index (e.g., a user's finger 614) contacts a user input surface (such as user input surface 606) the total internal reflection may be frustrated. In frustrated total internal reflection, an incident beam of electromagnetic radiation 608a may reflect, as a reflected beam of electromagnetic radiation 608c, back into the electromagnetic radiation source 602. Once the reflected beam of electromagnetic radiation 608c enters the electromagnetic radiation source 602, a self-mixing process may occur. As discussed with respect to FIGS. 5 and 6, self-mixing interference sensors, and associated components, may measure power variations occurring as a result of the self-mixing process and may result in a detection of a user input (e.g., a gesture on a user input surface).

FIG. 6B depicts an example of a second boundary condition between the user input surface 606 and the user's finger 615. In this second boundary condition, a second critical angle between the user input surface 606 and the user's finger 615 is created. Since the second critical angle is greater than the first critical angle (e.g., the critical angle present in FIG. 6A), the reflection of the incident beam of electromagnetic radiation 608a changes and, instead of reflecting away from the electromagnetic radiation source 602, reflects back into the electromagnetic radiation source 602.

FIG. 6C depicts a cross-sectional view of a part of a watch crown 600 when a user's finger 614 is hovering above a user input surface 606. Since the beam of electromagnetic radiation 608a contacts the watch crown 600 at a contact point 610 on the user input surface 606, the system does not detect the presence of the user's finger 614 and no reflected light returns to the electromagnetic radiation source 602. As a result, no (or minimal) self-mixing occurs. In this way, hovering above the user input surface 606 does not result in a user input and the system can avoid detecting events (e.g., gestures) that a user does not intend to act as a user input.

The boundary condition depicted in FIG. 6C may be the same boundary condition (e.g., a first boundary condition) as that depicted in FIG. 6A. That is, the critical angle (e.g., a first critical angle) between the user input surface 606 and the surrounding environment (e.g., air) may be the same as the critical angle depicted in FIG. 6A.

The material of the watch crown 600 may be glass, plastic, any other material, or any combination thereof, that is transparent to the incident beam of electromagnetic radiation 608a. The incident angle of the incident beam of electromagnetic radiation 608a may be selected such that the incident angle is greater than a first critical angle between the selected material and a common surrounding environment (e.g., air and water) and less than a second critical angle of a second boundary condition between the selected material and a user's body part (e.g., a user's finger). The watch crown 600 may be hollow and may be filled with, for example, an internal fluid 611 or may contain a vacuum. The watch crown 600 may have a diameter or thickness of any suitable dimension such as, for example, between 5 μm to 1 mm.

Though FIGS. 6A-6C depict an internal fluid 611 within an internal cavity of the watch crown 600, this is merely illustrative and other implementations are described herein. In some embodiments, the electromagnetic radiation source 602 may be in contact with (e.g., may directly abut) the watch crown 600. In other embodiments, the watch crown 600 may be solid instead of hollow (e.g., the watch crown 600 may be solid and formed of a single material).

In FIGS. 6A-6C, the electromagnetic radiation source 602 is positioned above a housing 612 and within an internal cavity of the watch crown 600. In some embodiments, the electromagnetic radiation source 602 may be positioned within an internal cavity of the housing 612 or may be located within a barrier between an internal cavity of the housing 612 and an internal cavity of the watch crown 600. Further, associated electrical components of the electromagnetic radiation source 602 may be positioned within the housing 612 (e.g., on a chip) and/or within a cavity of the watch crown 600. A number of photodiodes may be provided, either stacked below the electromagnetic radiation source 602 or may be placed separately from the electromagnetic radiation source 602, to detect, for example, diffusely reflected, specularly reflected, and/or refracted beams of electromagnetic radiation. The photodiodes may be communicatively coupled to one another and/or the electromagnetic radiation source to determine a position, velocity, speed, and/or movement of an object in contact with the watch crown 600. The electromagnetic radiation source 602 may be a self-mixing interference sensor in many embodiments.

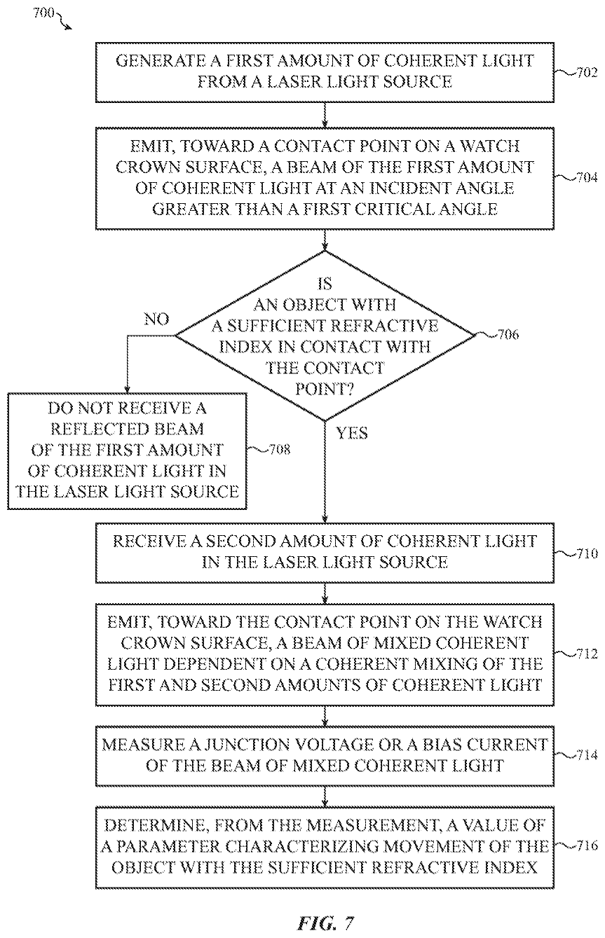

FIG. 7 illustrates an example method 700 of detecting an object with a sufficient refractive index in contact with a watch crown surface.

At step 702, a first amount of coherent light may be generated within a cavity of a laser light source (or any other electromagnetic radiation source). To generate the first amount of coherent light, the cavity of the laser light source may be electrically or optically pumped to generate electromagnetic radiation and a gain material within the cavity may amplify the electromagnetic radiation that reflects within the cavity. The step at 702 may be performed by, for example, a self-mixing interference sensor, an electromagnetic radiation source, or a laser, as described herein.

At step 704, the first amount of coherent light may escape the cavity, via, for example, a partially-transparent mirror. The first amount of coherent light may be emitted toward a contact point on a watch crown surface (e.g., a user input surface). The incident angle of the first amount of coherent light may be greater than a first critical angle between a first boundary condition between the watch crown surface and an external environment (e.g., air and water). In this way, the first amount of coherent light may undergo a total internal reflection with the watch crown surface. The incident angle may be set at the time of manufacture or may be configured to change as a position of the laser light source changes.

At step 706, instances where an object with a sufficient refractive index is in contact, or is not in contact, with the contact point on the watch crown surface are considered. A sufficient refractive index may be determined by Snell's law. In particular, an object with a sufficient refractive index may result in the incident angle of the first amount of coherent light be less than a second critical angle of a second boundary condition between the watch crown surface and the object (e.g., a body part of a user). In some examples, a user's finger may have a sufficient refractive index. In some examples, an article of clothing (e.g., a glove) may have a sufficient refractive index.

At step 708, an object with a sufficient refractive index is not in contact with the contact point on the watch crown surface. Instead, a medium and/or object with an insufficient refractive index may surround and/or be in contact with the watch crown surface. Examples of mediums and/or objects with insufficient refractive indices are water, air, wood, plastic, and the like. Mediums and/or objects with insufficient refractive indices result in a critical angle that is less than an incident angle of the first amount of coherent light. In these instances, the first amount of coherent light undergoes a total internal reflection and reflects off of the contact point and away from the laser light source. When this occurs, there is no user input detected on the watch crown surface and no user input command is initiated.

At step 710, an object with a sufficient refractive index is in contact with the contact point on the watch crown surface. Examples of objects with sufficient refractive indices are human skin, fabric, a stylus, and the like. Objects with sufficient refractive indices result in the first amount of coherent light undergoing frustrated total internal reflection and the first amount of coherent light may be reflected back into a cavity of the laser light source. The reflected coherent light may possess different optical properties than the first amount of coherent light. For example, the reflected coherent light may have a different wavelength, amplitude, frequency, and the like. The step at 710 may be performed by, for example, a self-mixing interference sensor, an electromagnetic radiation source, or a laser, as described herein.

At step 712, the laser light source may emit a beam of mixed coherent light dependent on a coherent mixing of the first amount of coherent light and the reflected coherent light. The mixed coherent light may be based on the difference in optical properties (e.g., a parameter change) between the first amount of coherent light and the reflected coherent light, as discussed herein. The mixed coherent light may be emitted toward the contact point on the watch crown surface and may exhibit different optical properties in real-time as coherent light reflected back into the laser light source varies.

At step 714, a junction voltage or a bias current of the laser may be measured. The junction voltage or the bias current may depend on the coherent mixing of the first amount of coherent light and the reflected coherent light within the laser light source. The junction voltage or the bias current may dynamically vary in response to a variation of the reflected coherent light. Alternatively or additionally, the operation(s) at step 714 may include measuring an optical power of the reflected coherent light. The operation(s) at step 714 may be performed by, for example, the sensor system, the electromagnetic radiation source, or the laser, as described herein.

At step 716, a value of a parameter characterizing a movement of the medium of a sufficient refractive index in contact with the watch crown may be detected from at least the measure of the junction voltage or the bias current. For example, the laser light source may measure a change in optical properties between the first amount of coherent light and the reflected coherent light, thereby detecting a movement (e.g., a velocity). Alternatively or additionally, the laser light source may detect the optical properties present in the reflected coherent light and may be configured to detect a movement (e.g., a velocity) of the medium of a sufficient refractive index. For example, if a user's finger is in contact with the watch crown, a velocity of the user's finger may be detected as the user's finger moves across a surface of the watch crown. Such velocity measurements may be updated dynamically as the reflected coherent light varies dynamically. The operation(s) at step 716 may be performed by, for example, the sensor system, the electromagnetic radiation source, or the laser, as described herein.

The determined parameter at step 716 may correspond to a gesture performed by a user on the watch crown surface. For example, some measurements may correspond to a fast swipe gesture. Other measurements may correspond to a slow tap gesture. By associating measurements with different types of gestures, a user may interact with an electronic device in a wide variety of ways.

At step 716, the measured junction voltage and/or bias current may be compared to a predetermined threshold value in order to minimize inputs due to noise. The predetermined threshold value may be selected to correspond to a time when an object with a sufficient refractive index is in contact with the contact point.

FIG. 8 depicts a cross-sectional view of a part of a watch crown 800 with a first electromagnetic radiation source 802a and a second electromagnetic radiation source 802b. To increase a sensing density of the system, multiple electromagnetic radiation sources, and associated electronics, may be provided. In this embodiment, the first electromagnetic radiation source 802a is provided with a first support structure 804a and the second electromagnetic radiation source 802b is provided with a second support structure 804b. The first electromagnetic radiation source 802a emits a first incident beam of electromagnetic radiation 808a1. The first incident beam of electromagnetic radiation 808a1 contacts a first contact point 810a and is reflected away from the first electromagnetic radiation source 802a as a first reflected beam of electromagnetic radiation 808b1, when a user is not contacting a user input surface 806 at the first contact point 810a. The second electromagnetic radiation source 802b emits a second incident beam of electromagnetic radiation 808a2. The second incident beam of electromagnetic radiation 808a2 contacts a second contact point 810b and is reflected away from the second electromagnetic radiation source 802b as a second reflected beam of electromagnetic radiation 808b2, when a user is not contacting the user input surface 806 at the second contact point 810b.

Though depicted when no object is contacting the user input surface 806, both the first electromagnetic radiation source 802a and the second electromagnetic radiation source 802b may operate in substantially similar manners as the electromagnetic radiation source 604 in FIGS. 6A-6C in situations where an object with a suitable refractive index is contacting the user input surface 806.

A user may contact either the first contact point 810a, the second contact point 810b, or both in order to make a user input. In an event that the user contacts both the first contact point 810a and the second contact point 810b, the system may detect a time between a detection of an object at the first contact point 810a and the second contact point 810b and may perform a user input based on the measured time difference. In another situation, a user may contact both the first contact point 810a and the second contact point 810b at the same time, resulting in a specific user input command.

Though only two electromagnetic radiation sources are depicted in FIG. 8, any number of electromagnetic radiation sources may be provided to increase the sensitivity of the system. For example, there may be four electromagnetic radiation sources each emitting a beam of electromagnetic radiation at 90° intervals around a perimeter of the watch crown 800. Each electromagnetic radiation source may be provided with a unique photodiode and may undergo an individual self-mixing procedure. Each electromagnetic radiation source may be provided with unique electronics (e.g., drive and detection electronics) or may share the electronics with all of the provided electromagnetic radiation sources.

In some embodiments, there may be one electromagnetic radiation source and associated optical elements (e.g., a beam splitter) to create many different contact points. In such embodiments, the associated optical elements may direct portions of emitted beam of electromagnetic radiation to different locations and self-mixing procedures may occur once portions of the emitted beams of electromagnetic radiation are reflected back into the electromagnetic radiation source.

As mentioned with above with respect to FIGS. 6A-6C, the position of the electromagnetic radiation sources is not limited to an internal cavity of the watch crown 800. The electromagnetic radiation sources may be positioned within, for example, a portion of a housing 812 or between a boundary of the housing 812 and the internal cavity of the watch crown 800. As long as the respective incident beams of electromagnetic radiation contact a contact point at a sufficient incident angle, the position of the laser light sources is not limited.

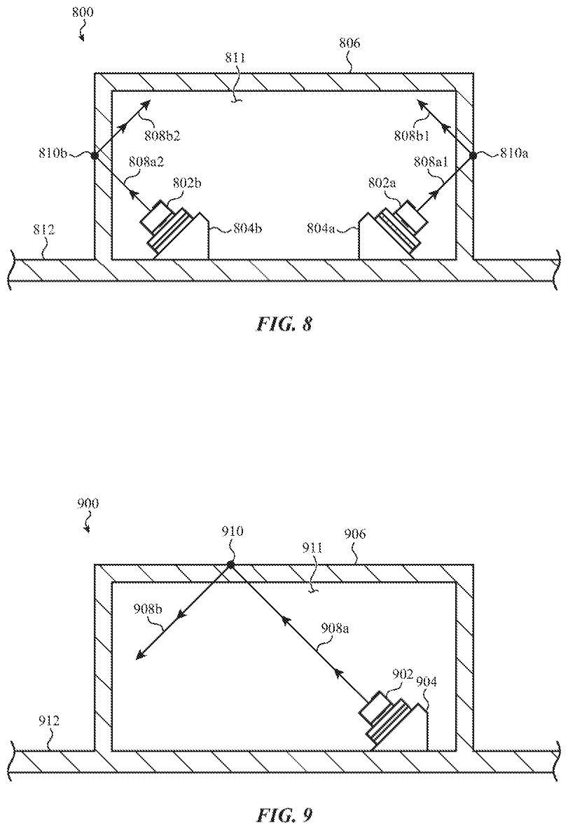

FIG. 9 depicts a cross-sectional view of a part of a watch crown 900 on a housing 912 when an electromagnetic radiation source 902 directs an incident beam of electromagnetic radiation 908a toward a top user input surface 906 of the watch crown 900. The electromagnetic radiation source 902 is positioned on a support structure 904 configured to direct the incident beam of electromagnetic radiation 908a toward a contact point 910 and at an incident angle larger than an associated critical angle. In the event that no suitable object is contacting the contact point 910, a reflected beam of electromagnetic radiation 908b may be reflected away from the electromagnetic radiation source 902. The operation of the embodiment shown in FIG. 9 may operate in a manner largely similar to the operation described with respect to FIGS. 6A-6C.

An electromagnetic radiation source 902 directing a beam of electromagnetic radiation toward a top user input surface 906 of the watch crown 900 may be used in conjunction with the systems disclosed with respect to FIGS. 6A-7. For example, a combined system may have contact points at both a side user input surface of the watch crown 900 and at a top user input surface of the watch crown 900. Contact points at the side user input surface of the watch crown 900 may be configured to allow the detection of, for example, scroll operations and contact points at the top user input surface of the watch crown 900 may be configured to allow the detection of, for example, selection operations.

As discussed herein, though FIGS. 6A-8 generally relate to a watch crown, the disclosure is not limited as such. Any user input surface may be incorporated in the disclosed system, including a button surface (e.g., a surface on the button 112) and a flat housing surface (e.g., a surface on the housing 106). In some embodiments, other electronic devices other than an electronic watch may incorporate self-mixing interference sensors as discussed herein. For example, a phone (e.g., a smart phone), tablet, desktop computer, and headphone may incorporated the disclosed system.

As discussed above, graphics displayed on the disclosed electronic devices may be manipulated through user inputs provided to a user input surface. FIGS. 10A-12B generally depict examples of changing a graphical output displayed on an electronic watch through inputs provided by force and/or movements across a surface of a crown assembly of the electronic watch. This manipulation (e.g., selection, acknowledgement, motion, dismissal, magnification, and the like) of a graphic may result in changes in operation of the electronic watch and/or graphical output displayed by the electronic watch. Although specific examples are provided and discussed, many operations may be performed by performing different gestures on a surface of a user input surface (e.g., a crown assembly). Accordingly, the following discussion is by way of example and not limitation.

FIG. 10A depicts an example electronic watch 1000 having a crown 1002. The crown 1002 may be similar to the examples described above and may comprise a self-mixing interference sensor within an internal cavity of the crown 1002. The crown 1002 may define a contact point and may receive user inputs when a user's finger moves across the contact point. As shown in FIGS. 10A-12B, the crown 1002 is not rotatable, though other embodiments where the crown 1002 is rotatable are considered. The crown 1002 may be depressible or may be fixed with respect to the electronic watch 1000.

A display 1004 provides a graphical output (e.g., shows information and/or other graphics). In some embodiments, the display 1004 may be configured as a touch-sensitive display capable of receiving touch and/or force input. In the current example, the display 1004 depicts a list of various items 1006a, 1006b, and 1006c, all of which are example graphics.

FIG. 10B depicts how the graphical output shown on the display 1004 changes in a first manner as a user's finger moves around a side user input surface of the crown 1002 (as indicated by the arrow S). As discussed herein, a self-mixing interference sensor may detect a velocity and/or position of a user's finger as the user moves the finger across a user input surface of the crown 1002. Even though the crown 1002 may remain static, a movement of the user's finger may correspond to a scrolling operation. In FIG. 10B, the scrolling operation moves through items on the display 1004, such that item 1006a is no longer visible and item 1006d is now displayed at the bottom of the display 1004. In addition, the second and third items 1006b and 1006c are now moved upwards on the display. This is one example of a scrolling operation that can be executed by interacting with a user input surface of the crown 1002. Such scrolling operations may provide a simple and efficient way to depict multiple items quickly and in sequential order. A speed/velocity and/or position of the scrolling operation may be controlled by a speed/velocity and/or position of the user's finger across a side user input surface of the crown 1002. Faster movement of a user's finger may yield faster scrolling, while slower movement of the user's finger may yield slower scrolling. The crown 1002 may receive an axial force (e.g., a force inward toward the display 1004 or watch body) to select an item from the list, in certain embodiments.

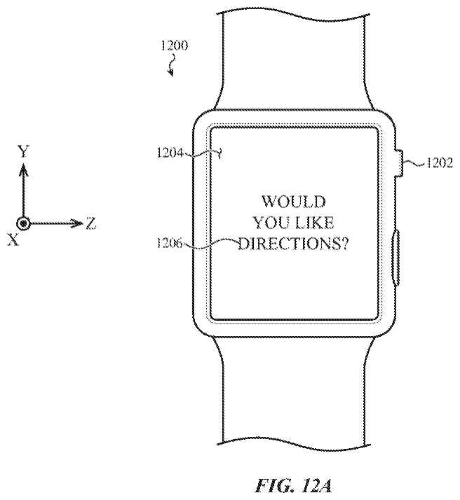

FIGS. 11A and 11B depict an example zoom operation of an electronic watch 1100. The display 1104 depicts a picture 1106 at a first magnification, shown in FIG. 11A. The picture 1106 is another example of a graphic. A user may apply a translating force (e.g., a force along the z-axis) or a lateral force (e.g., a force along the x-axis) to a user input surface of the crown 1102 of the electronic watch 1100. In response to an inward motion (illustrated in FIG. 11B as arrow I), the display 1104 may change a graphic in a second manner such as zooming into the picture 1106 so that a portion 1107 of the picture is shown at an increased magnification, as depicted in FIG. 11B. In some embodiments, a user may brush against a surface of the crown 1102 at a point where a beam of electromagnetic radiation from a self-mixing interference sensor contacts a user input surface of the crown 1102. In other embodiments, the user may pull or push the crown 1102 with respect to the housing of the electronic watch 1100. The direction of the zoom, the speed/velocity of the zoom, and/or the location of the zoom may be controlled through force/contact applied to a user input surface of the crown 1102. Applying force/contact/gesture to a user input surface of the crown 1102 in a first direction may zoom in, while applying force/contact/gesture to a user input surface of the crown 1102 in an opposite direction may zoom out. Alternatively, moving a finger across a user input surface (e.g., a side or a top user input surface) of the crown 1102 in a first direction may change the portion 1107 of the picture 1106 subject to the zoom effect. In some embodiments, applying an axial or translating force/motion to a user input surface of the crown 1102 may toggle between different zoom modes or inputs. In yet other embodiments, applying a contact to a user input surface of the crown 1102 may return the picture 1106 to the default magnification depicted in FIG. 11A.

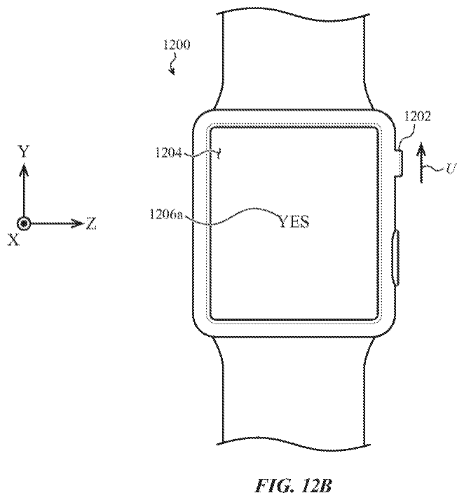

FIGS. 12A and 12B depict a possible use of the crown 1202 to change an operational state of the electronic watch 1200 or otherwise toggle between inputs. In FIG. 12A, the display 1204 depicts a question 1206 (e.g., “Would you like directions?”). As shown in FIG. 12B, a lateral movement (depicted by arrow U) may be applied to a top user input surface of the crown 1202 to answer the question. Applying an upward movement to the crown 1202 may be interpreted as an affirmative input and so “Yes” is displayed as graphic 1206a. Applying a movement in the opposite direction may be interpreted as a negative input and “No” may be displayed on the display 1204.

In the embodiment shown in FIGS. 12A and 12B, the movement applied to the crown 1202 is used to directly provide the user input, rather than select from options in a list (as discussed above with respect to FIGS. 10A and 10B).

As mentioned previously, movement across a user input surface of a crown of an electronic watch may control many functions beyond those listed here. Many self-mixing interference sensors may be provided within the crown (e.g., FIG. 8) and movement of an object (e.g., a user's finger) may be tracked as the object moves across the various sensors. Additionally, a velocity and/or speed of the object may be detected with respect to each self-mixing interference sensor. In this way, a wide variety of user input options may be detected. For example, the crown may receive movement across a user input surface of the crown to adjust a volume of an electronic device, a brightness of a display, or other operational parameters of the device. A user input may be applied to a user input surface of the crown to turn a display on or off or to turn the device on or off. Further, combinations of user inputs to a user input surface of the crown may likewise initiate or control any of the foregoing functions.

In some cases, the graphical output of a display may be responsive to user inputs applied to a touch-sensitive display (e.g., displays 1004, 1104, and 1204) in addition to inputs applied to a crown. The touch-sensitive display may include or be associated with one or more touch and/or force sensors that extend along an output region of a display and which may use any suitable sensing elements and/or sensing techniques to detect touch and/or force inputs applied to the touch-sensitive display. The same or similar graphical output manipulations that are produced in response to inputs applied to the crown may also be produced in response to inputs applied to the touch sensitive-display. For example, a swipe gesture applied to the touch-sensitive display may cause the graphical output to move in a direction corresponding to the swipe gesture. Similarly, a swipe gesture applied to the crown may cause the graphical output to move in a direction corresponding to the swipe gesture. As another example, a tap gesture applied to either the touch-sensitive display or the crown may cause an item to be selected or activated. In this way, a user may have multiple different ways to interact with and control an electronic watch. Further, while the crown may provide overlapping functionality with the touch-sensitive display, using the crown allows for the graphical output of the display to be visible (without being blocked by the finger that is providing the touch input).

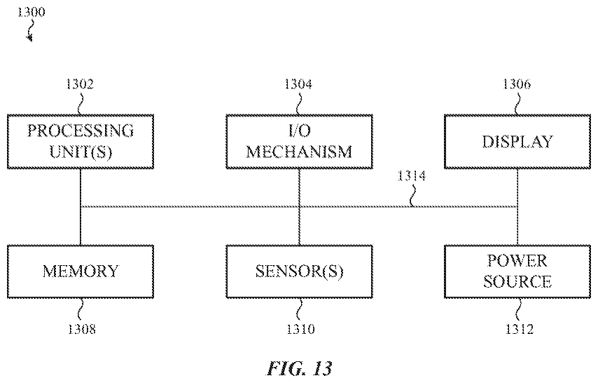

FIG. 13 shows a sample electrical block diagram of an electronic device 1300, which may take the form of any of the electronic watches or other electronic devices described with reference to FIGS. 1-12, or other portable or wearable electronic devices. The electronic device 1300 may include a processing unit(s) 1302 (e.g., a processor 1302), an input/output (I/O) mechanism 1304, a display 1306, a memory 1308, a sensor(s) 1310, and a power source 1312. The processing unit(s) 1302 may control some or all of the operations of the electronic device 1300, including the operation of self-mixing interference sensors as described herein. The processing unit(s) 1302 may communicate, either directly or indirectly, with some or all of the components of the electronic device 1300. For example, a system bus 1314 may provide communication between the processing unit(s) 1302, the power source 1312, the memory 1308, the sensor 1310, and the input/output mechanism 1304.

The processing unit(s) 1302 may be implemented as any electronic device capable of processing, receiving, or transmitting data or instructions. For example, the processing unit(s) 1302 may be a microprocessor, a central processing unit (CPU), an application-specific integrated circuit (ASIC), a digital signal processor (DSP), or combinations of such devices. As described herein, the term “processor” is meant to encompass a single processor or processing unit, multiple processors, multiple processing units, or other suitable configured computing element or elements.

The components of the electronic device 1300 may be controlled by multiple processors. For example, select components of the electronic device 1300 (e.g., a sensor 1310) may be controlled by a first processor and other components of the electronic device 1300 (e.g., the display 1306) may be controlled by a second processor, where the first and second processor may or may not be in communication with each other. In some cases, the processing unit(s) 1302 may determine a biological parameter of a user of the electronic device 1300, such as an electrocardiogram (EKG/ECG) of a user.

The I/O mechanism 1304 may transmit and/or receive data from a user or another electronic device. An I/O mechanism 1304 may include a display, a touch sensing input surface, one or more buttons (e.g., a graphical user interface “home” button), one or more cameras, one or more microphones or speakers, one or more ports such as a microphone port, and/or a keyboard. Additionally or alternatively, the I/O mechanism 1304 or port may transmit electronic signals via a communications network, such as a wireless and/or wired network connection. Examples of wireless and wired network connections include, but are not limited to, cellular WI-FI, BLUETOOTH (as a wireless technology standard), infrared, and Ethernet connections.

The display 1306 may receive and depict visual information and/or a graphical user interface to a user. The display 1306 may be any number of displays including, for example, a light-emitting diode (LED) display, an electroluminescent (ELD) display, an E-Ink display, a plasma display panel (PDP), a liquid crystal display (LCD), an organic light-emitting diode (OLED) display, and the like.

The memory 1308 may store electronic data that may be used by the electronic device 1300. For example, the memory 1300 may store electrical data or content such as, for example, audio and video files, documents and applications, device settings and user preferences, timing signals, control signals, and data structures or databases. The memory 1308 may be configured as any type of memory. By way of example only, the memory 1308 may be implemented as random access memory, read-only memory, flash memory, removable memory, other types of storage elements, or combinations of such devices.

The electronic device 1300 may also include one or more sensors 1310 positioned almost anywhere on the electronic device 1300. As discussed herein, one such sensor 1301 may be a self-mixing interference sensor. The sensor(s) 1310 may be configured to sense one or more type of parameters, such as, but not limited to, pressure, light, touch, heat, movement, relative motion, biometric data (e.g., biological parameters), and the like. For example, the sensor(s) 1310 may include a heat sensor, a position sensor, a light or optical sensor, an accelerometer, a pressure transducer, a gyroscope, a magnetometer, a health monitoring sensor, and the like. Additionally, the sensor(s) 1310 may utilize any suitable sensing technology, including, but not limited to, capacitive, ultrasonic, resistive, optical, ultrasound, piezoelectric, and thermal sensing technology. In some examples, the sensor(s) 1310 may include one or more electrodes.

The power source 1312 may be implemented with any device capable of providing energy to the electronic device 1300. For example, the power source 1312 may be one or more batteries or rechargeable batteries. Additionally or alternatively, the power source 1312 may be a power connector or power cord that connects the electronic device 1300 to another power source, such as via a wall outlet.

Other examples and implementations are within the scope and spirit of the disclosure and appended claims. For example, features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C). Further, the term “exemplary” does not mean that the described example is preferred or better than other examples.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

What is claimed is:

1. An electronic watch comprising:
a housing;
a user input device protruding from the housing and defining a user input surface; and
a self-mixing interference sensor including an electromagnetic radiation source; wherein:
the electromagnetic radiation source is configured to emit a beam of electromagnetic radiation toward the user input surface;
the user input surface is transparent to the beam of electromagnetic radiation; and
the beam of electromagnetic radiation has an angle of incidence, with respect to the user input surface:
greater than a first critical angle of a first boundary condition between the user input surface and air; and
less than a second critical angle of a second boundary condition between the user input surface and a body part of a user.

2. The electronic watch of claim 1, wherein the self-mixing interference sensor further includes a circuit configured to monitor one of a junction voltage and a bias current of the electromagnetic radiation source.

3. The electronic watch of claim 1, wherein:
the beam of electromagnetic radiation reflects back into the self-mixing interference sensor when the body part is contacting the user input surface; and
the self-mixing interference sensor identifies a type of gesture on the user input surface in response to detecting an optical property of the reflected beam of electromagnetic radiation.

4. The electronic watch of claim 1, wherein an output of the self-mixing interference sensor contains information related to at least one of a velocity or direction of motion of the body part as the body part moves across the user input surface.

5. The electronic watch of claim 4, wherein:
the user input device comprises a stationary crown; and
the user input surface comprises a circumference of the stationary crown.

6. The electronic watch of claim 1, wherein:
the self-mixing interference sensor produces an output indicative of changes from the first boundary condition to the second boundary condition, and from the second boundary condition to the first boundary condition.

7. The electronic watch of claim 6, wherein the user input device comprises a crown and the user input surface is a surface of the crown.

8. An electronic device comprising:
a frame;
a protrusion extending from the frame and defining an input surface of the electronic device;
a self-mixing interference sensor configured to emit a beam of electromagnetic radiation toward the input surface; and
a processor configured to detect a frustrated total internal reflection condition of the beam of electromagnetic radiation, at least partly in response to an output of the self-mixing interference sensor.

9. The electronic device of claim 8, wherein the self-mixing interference sensor is positioned within a cavity of the protrusion.

10. The electronic device of claim 8, wherein the self-mixing interference sensor is positioned within a cavity of the frame.

11. The electronic device of claim 8, wherein at least a majority of the beam of electromagnetic radiation reflects away from the self-mixing interference sensor when air contacts the input surface at a point where the beam of electromagnetic radiation contacts the input surface.

12. The electronic device of claim 8, wherein a portion of the beam of electromagnetic radiation reflects back into the self-mixing interference sensor when a body part of a user contacts the input surface at a point where the beam of electromagnetic radiation contacts the input surface.

13. The electronic device of claim 12, wherein the processor identifies a user input when the portion of the beam of electromagnetic radiation that reflects back into the self-mixing interference sensor exceeds a threshold amount.

14. The electronic device of claim 12, wherein the processor identifies a speed of the body part when an amount of the beam of electromagnetic radiation that reflects back into the self-mixing interference sensor changes more than a threshold amount.

15. An electronic watch comprising:
a hollow crown defining an interior cavity and having a first refractive index; and
a light-emitting sensor positioned within the interior cavity and configured to emit a beam of electromagnetic radiation toward an exterior surface of the hollow crown.

16. The electronic watch of claim 15, wherein:
the beam of electromagnetic radiation reflects off of the exterior surface and away from the light-emitting sensor when an incident angle of the beam of electromagnetic radiation is greater than a first critical angle between a first boundary of a first medium having a second refractive index and the hollow crown having the first refractive index; and
the beam of electromagnetic radiation reflects off of the exterior surface and back into the light-emitting sensor when the incident angle of the beam of electromagnetic radiation is less than a second critical angle between a second boundary of a second medium having a third refractive index and the hollow crown having the first refractive index.

17. The electronic watch of claim 15, wherein the light-emitting sensor detects a contact between the second medium and the hollow crown.

18. The electronic watch of claim 15, wherein the hollow crown is transparent to the beam of electromagnetic radiation.

19. The electronic watch of claim 15, wherein the light-emitting sensor signals an input when a threshold amount of the beam of electromagnetic radiation reflects off of the exterior surface and back into the light-emitting sensor.

20. The electronic watch of claim 15, wherein:
the beam of electromagnetic radiation contacts a circumference of the hollow crown before reflecting back into the light-emitting sensor as a reflected beam of electromagnetic radiation; and
the light-emitting sensor is configured to detect a velocity of a gesture based on an optical property of the reflected beam of electromagnetic radiation.
